(19) United States
(12) Patent Application Publication
(10) Pub. No.: US 2025/0098859 A1
(43) Pub. Date: Mar. 27, 2025

(54) Illuminated Pedicure Chair Device

(71) Applicant: Phu Nguyen, Anaheim, CA (US)

(72) Inventor: Phu Nguyen, Anaheim, CA (US)

(21) Appl. No.: 18/483,942

(22) Filed: Oct. 10, 2023

Related U.S. Application Data
(60) Provisional application No. 63/584,277, filed on Sep. 21, 2023.

(51) Int. Cl. A47C 1/11; A45D 29/18; A45D 44/02; A47C 1/06; A47C 7/50; A47C 7/62; A47C 7/72; F21V 11/18; F21V 23/04; F21V 33/00; F21W 131/301; F21Y 115/10

(52) U.S. Cl. CPC A47C 1/11; A45D 29/18; A45D 44/02; A47C 1/06; A47C 7/506; A47C 7/622; A47C 7/725; F21V 11/183; F21V 23/04; F21V 33/0012; F21W 2131/301; F21Y 2115/10

(57) ABSTRACT

An illuminated pedicure chair device is provided. The device is comprised of a pedicure chair body with at least one light preferably positioned on a surface of an armrest of the body. The light may be fixed or repositionable such that the light illuminates the foot area of the body while a user is receiving a pedicure. The light may be comprised of a glare shield that prevents a user sitting in the chair body from receiving glare from the light.

### CROSS-REFERENCE TO RELATED APPLICATION

The present application claims priority to, and the benefit of, U.S. Provisional Application No. 63/584,277, which was filed on Sep. 21, 2023, and is incorporated herein by reference in its entirety.

### FIELD OF THE INVENTION

The present invention relates generally to the field of pedicure chairs. More specifically, the present invention relates to an illuminated pedicure chair device with an integrated light that illuminates a foot area of the device. Accordingly, the present disclosure makes specific reference thereto. Nonetheless, it is to be appreciated that aspects of the present invention are also equally applicable to other like applications, devices, and methods of manufacture.

### BACKGROUND

Nail salon workers may struggle to see the toes of the customers during a pedicure. This difficulty arises due to various factors such as the positioning of the client, the angle of the chair, or even the inherent lighting conditions of the salon. As a result, salon owners are often compelled to invest in lighting to enhance visibility. However, said lighting can be expensive, and installing specialized ceiling lighting can be a considerable investment for salon owners. Not only does it involve a significant upfront cost, but it also potentially leads to increased utility bills due to the higher energy consumption of these powerful lights.

An alternative solution to this dilemma is placing an external light next to the pedicure chair. While this approach might be less expensive and easier to implement, it comes with its own set of challenges. The presence of an external light can disrupt the aesthetics of the salon. Salon ambiance is a critical component of customer experience, and the addition of a seemingly out-of-place element can detract from the carefully curated atmosphere that salon owners strive to create. Customers seeking a serene and visually pleasing environment might find this discordance unappealing, which could ultimately affect their overall satisfaction and loyalty to the salon.

Moreover, the placement of external lights can also pose practical issues, such as the salon space becoming cluttered, the potential risk of tripping over wires, or the inconvenience of adjusting the lights for different customers and services. These concerns necessitate additional time and effort from the salon staff, potentially affecting the efficiency of the salon operations.

Therefore, there exists a long-felt need in the art for a lighting solution for a nail salon. There also exists a long-felt need in the art for a lighting solution for a nail salon that can be used to illuminate the feet of customers getting pedicures. More specifically, there exists a long-felt need in the art for an illuminated pedicure chair device that illuminates the feet of a user sitting in the device. In addition, there exists a long-felt need in the art for an illuminated pedicure chair device that illuminates the feet of a user sitting in the device wherein the device does not require additional lighting to be implemented or space to be used to house lighting.

The subject matter disclosed and claimed herein, in one embodiment thereof, comprises an illuminated pedicure chair device. The device is comprised of a pedicure chair body with at least one light preferably positioned on a surface of an armrest of the body. The light may be fixed or repositionable such that the light illuminates the foot area of the body while a user is receiving a pedicure. The light may be comprised of a glare shield that prevents a user sitting in the chair body from receiving glare from the light. As a result, the device discretely provides the necessary light for a successful pedicure.

In this manner, the illuminated pedicure chair device of the present invention accomplishes all the foregoing objectives and provides a lighting solution for a nail salon that can be used to illuminate the feet of customers getting pedicures. More specifically, the device illuminates the feet of a user sitting in the device. Because the lighting is integrated into the chair itself, the device does not require additional lighting to be implemented or space to be used to house lighting other than the existing space a pedicure chair would already take up in the salon.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an illuminated pedicure chair device comprised of a pedicure chair body with at least one light that illuminates a foot area of the body. Further, the light illuminates the foot area without providing glare to a user sitting in the body.

The body may be any type, size, and style of pedicure chair that may be manually or electronically adjustable. In addition, the body is comprised of at least one armrest. The armrest is comprised of at least one light. The light is positioned within at least one housing, wherein the light may be repositioned within the housing to direct a light beam from the light towards the foot area to illuminate the feet of a user sitting in the body while getting a pedicure. The light is preferably angled such that the light beam is not visible and does not reflect back towards the user sitting in the body while the light illuminates the foot area. To further prevent reflection towards a user sitting in the body, the housing may be comprised of at least one glare shield.

The present invention is also comprised of a method of using the device. First, a device is provided comprised of a pedicure chair body with at least one light that illuminates the foot area of the body. Then, a user sitting in the body receiving a pedicure (or a salon worker) can activate the light via a button such that the light illuminates the foot area. A user/salon worker can then reposition (i.e., tilt) the light within a housing of the body to better position the light towards the foot area. Further, at least one glare shield can be rotated and positioned around the light such that the light beam from the light does not irritate a user sitting in the body via glare.

Accordingly, the illuminated pedicure chair device of the present invention is particularly advantageous as it provides a lighting solution for a nail salon that can be used to illuminate the feet of customers getting pedicures. More specifically, the device illuminates the feet of a user sitting in the device. Because the lighting is integrated into the chair itself, the device does not require additional lighting to be implemented or space to be used to house lighting other than the existing space a pedicure chair would already take up in the salon. In this manner, the illuminated pedicure chair device overcomes the limitations of existing options for providing light during a pedicure in a nail salon that is known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an illuminated pedicure chair device of the present invention in accordance with the disclosed architecture;

FIG. 2 illustrates an enhanced perspective view of an armrest of one potential embodiment of an illuminated pedicure chair device of the present invention in accordance with the disclosed architecture;

FIG. 3 illustrates an enhanced perspective view of an armrest of one potential embodiment of an illuminated pedicure chair device of the present invention in accordance with the disclosed architecture; and

FIG. 4 illustrates a flowchart of a method of using one potential embodiment of an illuminated pedicure chair device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a lighting solution for a nail salon. There also exists a long-felt need in the art for a lighting solution for a nail salon that can be used to illuminate the feet of customers getting pedicures. More specifically, there exists a long-felt need in the art for an illuminated pedicure chair device that illuminates the feet of a user sitting in the device. In addition, there exists a long-felt need in the art for an illuminated pedicure chair device that illuminates the feet of a user sitting in the device wherein the device does not require additional lighting to be implemented or space to be used to house lighting.

The present invention, in one exemplary embodiment, is comprised of an illuminated pedicure chair device. The device is comprised of a pedicure chair body with at least one light that illuminates a foot area of the body. Further, the light illuminates the foot area without providing glare to a user sitting in the body.

The body may be any type, size, and style of pedicure chair that may be manually or electronically adjustable and is preferably comprised of at least one armrest. The armrest is comprised of at least one light positioned within at least one housing, wherein the light may be repositioned within the housing to direct a light beam from the light towards the foot area to illuminate the feet of a user sitting in the body while getting a pedicure. The light is preferably angled such that the light beam is not visible and does not reflect back towards the user sitting in the body while the light illuminates the foot area. To further prevent reflection towards a user sitting in the body, the housing may be comprised of at least one glare shield.

The present invention is also comprised of a method of using the device. First, a device is provided comprised of a pedicure chair body with at least one light that illuminates the foot area of the body. Then, a user sitting in the body receiving a pedicure (or a salon worker) can activate the light via a button such that the light illuminates the foot area. A user/salon worker can then reposition (i.e., tilt) the light within a housing of the body to better position the light towards the foot area. Further, at least one glare shield can be rotated and positioned around the light such that the light beam from the light does not irritate a user sitting in the body via glare.

Accordingly, the illuminated pedicure chair device of the present invention is particularly advantageous as it provides a lighting solution for a nail salon that can be used to illuminate the feet of customers getting pedicures. More specifically, the device illuminates the feet of a user sitting in the device. Because the lighting is integrated into the chair itself, the device does not require additional lighting to be implemented or space to be used to house lighting other than the existing space a pedicure chair would already take up in the salon. In this manner, the illuminated pedicure chair device overcomes the limitations of existing options for providing light during a pedicure in a nail salon that is known in the art.

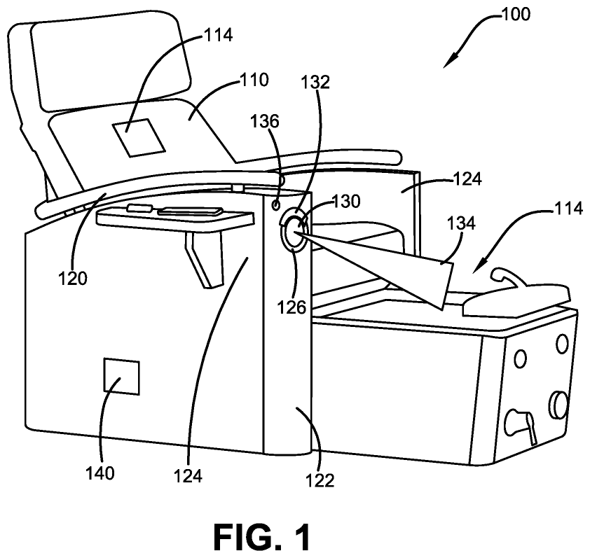

Referring initially to the drawings, FIG. 1 illustrates a perspective view of one potential embodiment of an illuminated pedicure chair device 100 of the present invention in accordance with the disclosed architecture. The device 100 is comprised of a pedicure chair body 110 with at least one light 130 that illuminates a foot area 112 of the body 110. More specifically, the light 130 illuminates the foot area 112 without providing glare to a user sitting in the body 110.

The body 110 may be any type, size, and style of pedicure chair that may be manually or electronically adjustable. The body 110 may have any feature 114 associated with a pedicure chair such as, but not limited to, a seat, an adjustable footrest, a built-in sink or basin for soaking feet, a single-handle faucet, a spray hose, a cushioned backrest, a control panel for adjusting settings, a massage function, reclining mechanisms, a built-in cup holders, etc.

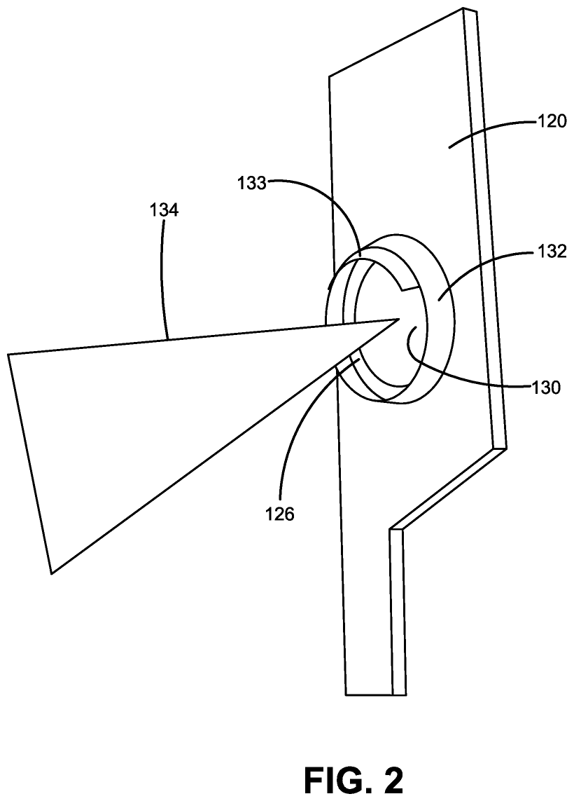

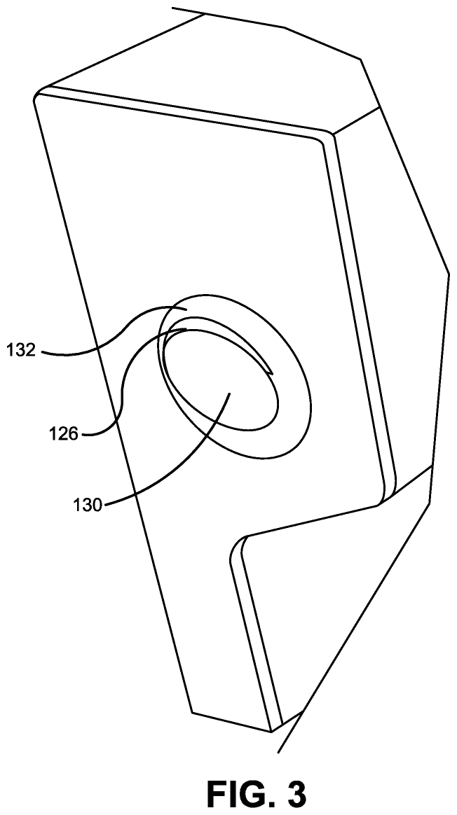

In addition, the body 110 is comprised of at least one armrest 120. The armrest 120 is comprised of at least one light 130, as seen in FIG. 2 and FIG. 3. The light 130 is preferably positioned on the front surface 122 of the armrest 120. However, the light 130 may be positioned on an interior/exterior side surface 124 or any other position on the armrest 120 or the body 110.

The light 130 is positioned within at least one housing 126. The light 130 can be repositioned within the housing 126 to direct a light beam 134 from the light 130 towards the foot area 112 to illuminate the feet of a user sitting in the body 110 while getting a pedicure. More specifically, the light 130 can preferably be tilted 180 degrees or less relative to both the x-axis and y-axis of the housing 126.

In one embodiment, the light 130 has limited rotation within the housing 126 such that the light 130 has a field of view of 17 degrees. In this embodiment, a light beam 134 produced by the light 130 exits the light 130 at a 10-degree angle (relative to the center of the light 130) towards the foot area 112. This angle ensures that the light 130 is not visible and does not reflect back towards the user sitting in the body 110 while the light 130 illuminates the foot area 112 to provide better visibility to a worker giving a pedicure. In one embodiment, the light 130 cannot be repositioned and is fixed in position.

To further prevent reflection towards a user sitting in the body 110, the housing 126 may be comprised of at least one glare shield 132, as seen in FIG. 2 and FIG. 3. The shield 132 has at least one raised edge 133 which further blocks the light beam 134 from being visible by the user sitting in the body 110. In one embodiment, the glare shield 132 may be rotatable 360 degrees around the housing 126 and/or light 130 to allow the positioning of the shield 132 and edge 133 to block the light beam 134 as needed depending on the exact positioning of the user sitting in the body 110. This further ensures a user sitting in the body 110 is undisturbed by the light 130.

The light 130 is preferably an LED light and/or UV light but may be any light type known in the art. The light 130 preferably has a plurality of brightness levels. The light 130 can also preferably illuminate a plurality of colors. The brightness level and color of the light 130 may be controlled by at least one button 136 positioned on the device 100.

The light 130 receives power via at least one battery 140. The battery 140 may supply power to all mechanical aspects of the device 100 in the event that the device 100 is motorized. The light 130 is preferably removable from the housing 126 such that it can easily be replaced when burnt out.

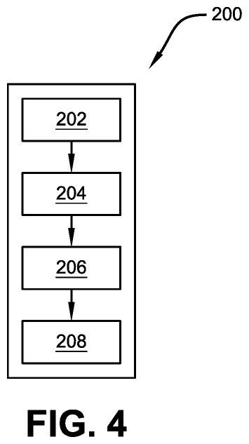

The present invention is also comprised of a method of using 200 the device 100, as seen in FIG. 4. First, a device 100 is provided comprised of a pedicure chair body 110 with at least one light 130 that illuminates the foot area 112 of the body 110 [Step 202]. Then, a user sitting in the body 110 receiving a pedicure (or a salon worker) can activate the light 130 via a button 136 such that the light 130 illuminates the foot area 112 [Step 204]. A user/salon worker can then reposition (i.e., tilt) the light 130 within a housing 126 of the body 110 to better position the light 130 towards the foot area 112 [Step 206]. Further, at least one glare shield 132 can be rotated and positioned around the light 130 such that the light beam 134 from the light 130 does not irritate a user sitting in the body 110 via glare [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “illuminated pedicure chair device” and “device” are interchangeable and refer to the illuminated pedicure chair device 100 of the present invention.

Notwithstanding the foregoing, the illuminated pedicure chair device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the illuminated pedicure chair device 100 as shown in the FIGS. are for illustrative purposes only, and that many other sizes and shapes of the illuminated pedicure chair device 100 are well within the scope of the present disclosure. Although the dimensions of the illuminated pedicure chair device 100 are important design parameters for user convenience, the illuminated pedicure chair device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An illuminated pedicure chair device comprising:
a pedicure chair body comprised of a foot area and an armrest; and
a light positioned on the armrest, wherein the light illuminates the foot area.

2. The illuminated pedicure chair device of claim 1, wherein the light is positioned on a front surface of the armrest.

3. The illuminated pedicure chair device of claim 1, wherein the light is positioned on a side surface of the armrest.

4. The illuminated pedicure chair device of claim 1, wherein the light is repositionable.

5. The illuminated pedicure chair device of claim 1, wherein the pedicure chair body is comprised of a seat, an adjustable footrest, a built-in sink, a single-handle faucet, a spray hose, a cushioned backrest, a control panel, a massage function, a reclining mechanism, or a built-in cup holder.

6. An illuminated pedicure chair device comprising:
a pedicure chair body comprised of a foot area and an armrest;
a housing positioned on the armrest;
a light positioned within the housing, wherein the light illuminates the foot area.

7. The illuminated pedicure chair device of claim 6, wherein the light is comprised of a glare shield.

8. The illuminated pedicure chair device of claim 7, wherein the glare shield is comprised of a raised edge.

9. The illuminated pedicure chair device of claim 6, wherein the glare shield can rotate 360 degrees around the housing.

10. The illuminated pedicure chair device of claim 6, wherein the glare shield can rotate 360 degrees around the light.

11. The illuminated pedicure chair device of claim 6, wherein the light can be repositioned within the housing.

12. The illuminated pedicure chair device of claim 11, wherein the light can be repositioned 180 degrees relative to the x-axis and y-axis of the housing.

13. The illuminated pedicure chair device of claim 6, wherein the light is comprised of a brightness level.

14. The illuminated pedicure chair device of claim 13, wherein the brightness level can be controlled by a button.

15. The illuminated pedicure chair device of claim 6, wherein the light produces a 10-degree light beam relative to the center of the light.

16. The illuminated pedicure chair device of claim 6, wherein the light is comprised of a field of view of 17 degrees.

17. The illuminated pedicure chair device of claim 6, wherein the light is comprised of an LED light.

18. The illuminated pedicure chair device of claim 6, wherein the light is comprised of a UV light.

19. The illuminated pedicure chair device of claim 6, wherein the pedicure chair body is comprised of a seat, an adjustable footrest, a built-in sink, a single-handle faucet, a spray hose, a cushioned backrest, a control panel, a massage function, a reclining mechanism, or a built-in cup holder.

20. A method of using an illuminated pedicure chair device, the method comprising:
providing an illuminated pedicure chair device comprised of a pedicure chair body comprised of a foot area, also comprised of a light that illuminates the foot area;
activating the light via a button such that the light illuminates the foot area;
repositioning the light within a housing of the pedicure chair body to better position the light towards the foot area; and
rotating and positioning a glare shield around the light such that a light beam produced by the light does not irritate a user sitting in the pedicure chair body.
